(19) United States
(12) Patent Application Publication
(10) Pub. No.: US 2025/0196197 A1
(43) Pub. Date: Jun. 19, 2025

(54) APPARATUS AND METHOD FOR CLEANING FILTER PLATES

(71) Applicant: CSL Behring LLC, King of Prussia, PA (US)

(72) Inventor: Donald Wesley Gallagher, Bourbonnais, IL (US)

(73) Assignee: CSL Behring LLC, King of Prussia, PA (US)

(21) Appl. No.: 18/847,807

(22) PCT Filed: Mar. 17, 2023
(86) PCT No.: PCT/IB2023/052612

§ 371 Date: Sep. 17, 2024

Related U.S. Application Data
(60) Provisional application No. 63/321,338, filed on Mar. 18, 2022.

(51) Int. Cl. B08B 3/02; B01D 41/04

(52) U.S. Cl. CPC B08B 3/022; B01D 41/04; B08B 3/024

(57) ABSTRACT

A wash rack (100) for cleaning filter plates is described. The wash rack comprises a front face spray assembly comprising a plurality of fixed front spray nozzles (110) spaced along a first axis and a rear face spray assembly comprising a plurality of fixed rear spray nozzles (120) along a second axis for directing cleaning fluid spray towards the front and rear surfaces of a filter plate positioned therebetween.

### TECHNICAL FIELD

The present invention is directed to a wash rack, and in particular to a wash rack for cleaning filter press filter plates. The present invention is further directed to a cleaning system for filter press filter plates and a method of cleaning filter press filter plates.

### BACKGROUND

In the processing and purification of blood plasma products, a variety of separation processes may be employed to arrive at the desire product. A commonly used process for further processing blood plasma fractions to remove solid contaminants is to filter the blood plasma fraction using a filter press.

Filtration or separation processes are required to purify or separate larger solid contaminants from blood plasma fractions in order to further process blood plasma fractions to obtain the required protein component. A filter press comprising a plurality of filter plates pressed together is commonly used to separate the solid and liquid phases. A filter aid may be added to facilitate the separation process.

During filtration using a filter press, the liquid phase (filtrate) is collected and the solid phase, which may include a filter aid, forms a filter cake on the filter plates. After filtration is complete, the filter plates are separated. During this separation, a portion of the filter cake may dislodge from the surface of the filter plates, however a filter cake residue remains. Prior to a subsequent filtration, the plates must undergo a cleaning process to remove this residue to ensure efficient operation of the filter plates and avoid cross-contamination. The filter press must necessarily be offline during the plate cleaning process, with the time offline determined by the time taken to achieve an adequate cleaning of the plates.

Current filter plate cleaning processes utilised in plasma separation comprises cleaning the filter plates in a cleaning bay in which a rotating nozzle arrangement is used to spray water across the front and rear surfaces of the filter plate in order to remove residual filter cake.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

According to one aspect of the present disclosure, there is provided a wash rack for cleaning filter plates, the wash rack comprising:
a filter plate front face spray assembly comprising a plurality of fixed front spray nozzles spaced along a first axis, wherein each front spray nozzle is a flat spray nozzle having a nozzle outlet configured to produce a fan-shaped front jet, and wherein each nozzle outlet is at an angle relative to the first axis, the angle of the nozzle outlet defining the angle of the produced fan-shaped front jet relative to the first axis.

According to the present disclosure, a cleaning system comprising:
a wash rack comprising a filter plate front face spray assembly comprising a plurality of fixed front spray nozzles spaced along a first axis, wherein each front spray nozzle is a flat spray nozzle having a nozzle outlet configured to produce a fan-shaped front jet, and wherein each nozzle outlet is at an angle relative to the first axis, the angle of the nozzle outlet defining the angle of the produced fan-shaped front jet relative to the first axis; and
a filter plate carriage,
wherein at least one of the wash rack and the filter plate carriage is movable relative to the front face spray assembly.

According to the present disclosure, there is further provided a method of cleaning a filter plate having a front face and a rear face, the method comprising:
generating a filter plate front face cleaning spray, the front face cleaning spray comprising a plurality of fan-shaped front jets from a plurality of front outlets spaced along a first axis, wherein each of the fan-shaped front jets is fixed at an angle relative to the first axis;
generating from a plurality of rear face outlets spaced along a second axis a filter plate rear face cleaning spray, the rear face cleaning spray comprising a plurality of fan-shaped rear face fluid jets directed toward the first axis, wherein each fan-shaped rear face fluid jet is associated with a corresponding fan-shaped front face fluid jet, and each fan-shaped rear face fluid jet is aligned with the corresponding fan-shaped front face fluid jet;
positioning a filter plate spaced from the first axis; and
moving at least one of the front face cleaning spray and the filter plate,
wherein relative movement of the filter plate and the front face cleaning spray moves the fan-shaped front jets across the filter plate front face thereby to define a front face spray cleaning profile on the front face surface, the front face spray cleaning profile comprising a plurality of parallel front cleaning bands, each front cleaning band associated with a respective fan-shaped front jet, wherein each front cleaning band at least partially overlaps with an adjacent front cleaning band.

### BRIEF DESCRIPTION OF DRAWINGS

Embodiments of the disclosure will now be described by way of example only with reference to the accompanying drawings in which:

FIG. 1 shows a front view of a wash rack according to an embodiment of the present disclosure;

FIG. 2 shows a perspective view of a wash rack according to an embodiment of the present disclosure;

FIG. 3 shows a front view of a filter plate demonstrating the spray pattern of a spray assembly according to the present disclosure;

FIGS. 4a and 4b show a filter plate face spray cleaning profile for various combinations of fixed nozzles and edge nozzles according to the present disclosure;

FIG. 5 shows a front view of a flat spray nozzle according to an embodiment of the present disclosure; and

FIG. 6 shows a partial side view of a front face spray assembly according to an embodiment of the present disclosure.

### DEFINITIONS

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

A “flat spray nozzle” is a nozzle that generates a fan-shaped jet of liquid droplets. The shape of the fan-shaped jet will be dependent on the configuration of the outlet, for example defining the spray angle (i.e. defining the degree of angular fanning) of the jet and the thickness of the fan.

The “spray impact pattern” is defined as the pattern formed by the jet impacting a surface placed in front of the jet, for example with respect to the surface being placed perpendicular to the jet. As will be understood, the coverage and intensity of the spray impact pattern on the surface will vary with the distance of the surface from the outlet. Where a flat spray nozzle is used, the spray impact pattern generated is typically a flat, oval spray pattern with tapered edges, however other flat, elongate shapes may be achieved such as a stadium shape spray pattern (i.e. rectangular with rounded corners).

As used herein, the term “nozzle outlet” is used to define the origin of the final spray jet that is produced by the nozzle. For example, a flat spray nozzle may include an elongate slot having a length and width defining the spray angle and thickness of the spray jet. In such nozzles, this elongate slot is considered the nozzle outlet. However, it will be appreciated that other nozzle configurations may be utilised to produce the fan-shaped jet. For example, the fan-shaped jet may be formed by deflection of a first jet of fluid by a nozzle surface.

### DETAILED DESCRIPTION OF EXEMPLARY EMBODIMENTS

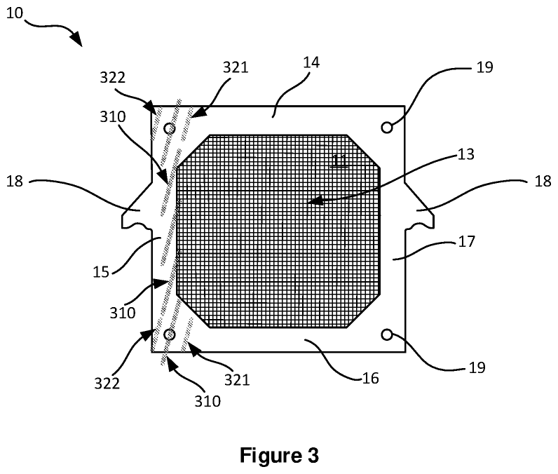

Referring initially to FIG. 3, there is shown an example filter press filter plate (10). The filter plate has a front face (11) and a rear face (not shown). The filter plate comprises a filter portion (13) surrounded by edges (14, 15, 16, 17). Filter plate support members (18) extend from the side edges (15, 17) of the filter plate (10). Apertures (19) for flow of the filtrate extend through corners of the filter plate (10). During filtration, for example of a blood plasma fraction, a filter cake forms on the front and rear faces.

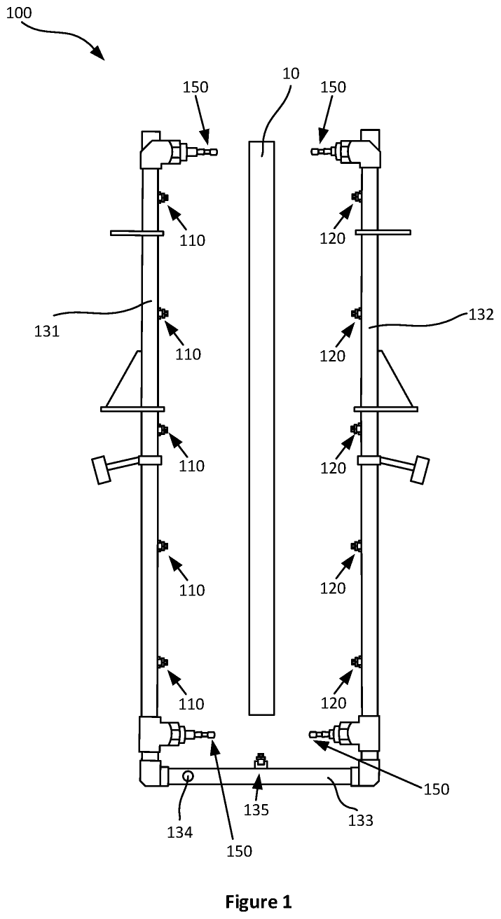

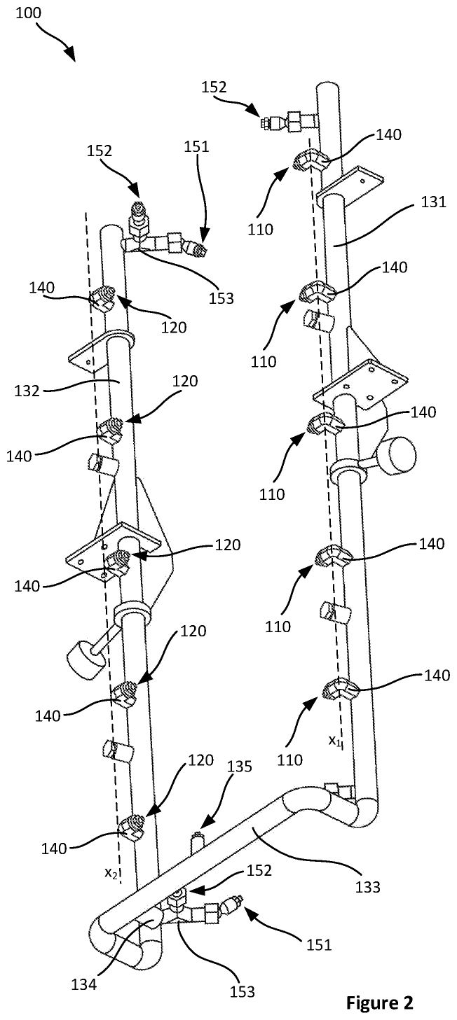

With reference to FIGS. 1 and 2, there is provided a wash rack (100) for cleaning filter plates (10).

The wash rack (100) comprises a filter plate front face spray assembly comprising a plurality of fixed front spray nozzles (110) spaced along a first axis (X₁), and a filter plate rear face spray assembly comprising a plurality of fixed rear spray nozzles (120) spaced along a second axis (X₂). The front spray nozzles may be evenly spaced along the first axis (X₁). Similarly, the rear spray nozzles may be evenly spaced along the second axis (X₂).

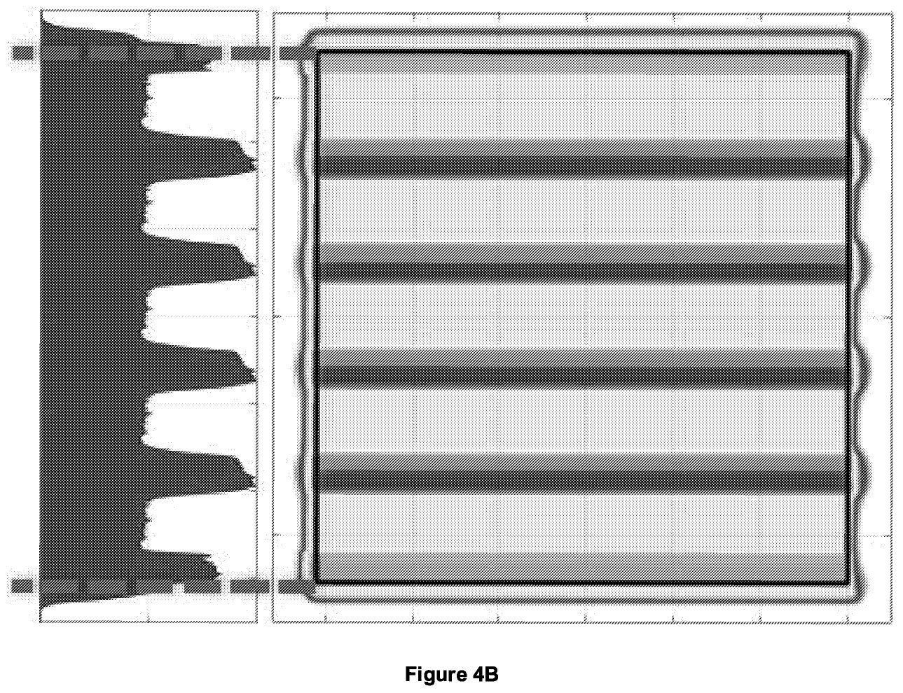

The outlets of the fixed front spray nozzles (110) are directed toward the second axis, and the outlets of the fixed rear spray nozzles (120) are directed towards the first axis. Each front spray nozzle (110) and each rear spray nozzle (120) is a flat spray nozzle, for example as shown in FIG. 5, having a nozzle outlet configured to produce a fan-shaped jet (400). In an embodiment, each nozzle outlet is defined by an elongate slot (115) having a length and width defining the spray angle (a) and thickness of the jets.

Jets of fluid formed by such flat spray nozzles are fan-shaped and provide an elongate spray pattern. The height and width of the spray pattern on a surface at a given distance and fluid pressure will vary depending on the length and width of the elongate slot (115) defining the nozzle outlet.

The spray angle (a) of the fixed flat spray nozzles (110, 120) may be from 15 degrees to 150 degrees. For example, the spray angle may be 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 125 degrees, 130 degrees, 135 degrees, 140 degrees, 145 degrees, or 150 degrees. In an embodiment, each of the front spray nozzles (110) and rear spray nozzles (120) has an 80 degree spray angle. The spray angle (a) may be selected to ensure adequate coverage of the filter plate surfaces during cleaning.

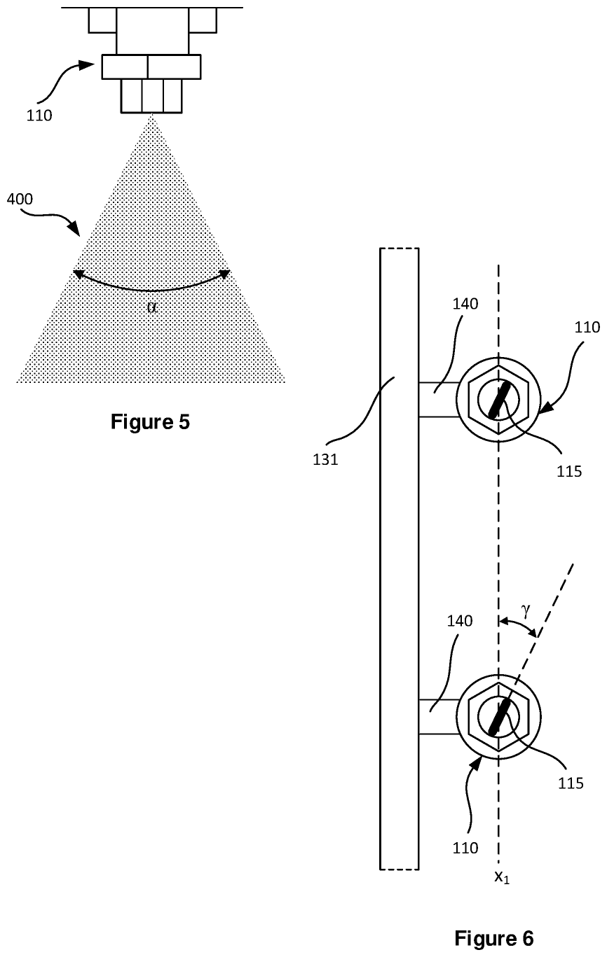

As best shown in FIG. 6, each front spray nozzle (110) is at an angle (γ) relative to the first axis (X₁), the angle of the nozzle outlet defining the angle of the produced fan-shaped front jet relative to the first axis (X₁). In an embodiment where the nozzle outlet is defined by an elongate slot (115), each front spray nozzle (110) is oriented such that the elongate slot (115) is angled relative to the first axis (X₁), for example as shown in FIG. 6. As can be seen in FIG. 3, this provides an angled spray impact pattern (310) from each nozzle relative to the side edges (15, 17) of the filter plate (10).

The angle (γ) of the nozzle outlets of the front spray nozzles (110) relative to the first axis (X₁) may be from 1 degree to 45 degrees, for example from 1 degree to 25 degrees, from 1 degree to 15 degrees, for example 5 degrees. That is, the angle (γ) of the elongate slot relative to the first axis (X₁) may be 1 degree, 2 degrees, 3 degrees, 4 degrees, 5 degrees, 6 degrees, 7 degrees, 8 degrees, 9 degrees, 10 degrees, 11 degrees, 12 degrees, 13 degrees, 14 degrees, 15 degrees, 20 degrees, 25 degrees, 30 degrees, 35 degrees, 40 degrees, or 45 degrees.

Preferably, each of the front spray nozzles (110) is oriented such that the nozzle outlets are all at the same angle (γ) relative to the first axis (X₁).

Similarly, each rear spray nozzle (120) is at an angle relative to the second axis (X₂), the angle of the nozzle outlet defining the angle of the produced fan-shaped front jet relative to the second axis (X₂). In an embodiment where the nozzle outlet is defined by an elongate slot, each rear spray nozzle (120) is oriented such that the elongate slot is angled relative to the second axis (X₂) in a similar manner as described above with regard to the orientation of the front spray nozzles (110) relative to the first axis (X₁).

The angle of the nozzle outlets of the rear spray nozzles (120) relative to the second axis (X₂) may be from 1 degree to 45 degrees, for example from 1 degree to 25 degrees, from 1 degree to 15 degrees, for example 5 degrees. That is, the angle of the elongate slot relative to the first axis may be 1 degree, 2 degrees, 3 degrees, 4 degrees, 5 degrees, 6 degrees, 7 degrees, 8 degrees, 9 degrees, 10 degrees, 11 degrees, 12 degrees, 13 degrees, 14 degrees, 15 degrees, 20 degrees, 25 degrees, 30 degrees, 35 degrees, 40 degrees, or 45 degrees.

In an embodiment, the nozzle outlet of each rear spray nozzle (120) is directly facing the nozzle outlet of a corresponding front spray nozzle (110). The nozzle outlet of each rear spray nozzle (120) may further be aligned with the nozzle outlet of the corresponding front spray nozzle (110). In this embodiment, the rear spray nozzles (120) are a mirror image of the front spray nozzles (110) such that the projected fan-shaped front jets and would impact corresponding projected fan-shaped rear jets at a midpoint between the first and second spray assemblies.

Preferably, each rear spray nozzle (120) is oriented such that the nozzle outlets are all at the same angle relative to the second axis (X₂).

The wash rack (100) further comprises a wash rack frame (130) on which the front face spray assembly and the rear face spray assembly are mounted.

While each of the nozzles associated with the wash rack (100) will now be described as being supplied with fluid via the wash rack frame (130), it will be appreciated that fluid supply to the nozzles may occur by other means. Further, the nozzles associated with the wash rack (100) may be supplied with fluid individually or in one or more groups from separate fluid supply lines.

As shown in FIGS. 1 and 2, the wash rack frame (130) is U-shaped, comprising a front fluid feed pipe (131) in fluid communication with each of the plurality of front spray nozzles and a rear fluid feed pipe (132) in fluid communication with each of the plurality of rear spray nozzles. In an embodiment, each front spray nozzle (110) is connected to the front fluid feed pipe (131) by a 90 degree elbow (140) extending laterally from the front fluid feed pipe. Similarly, each rear spray nozzle (120) may be connected to the rear fluid feed pipe (132) by a 90 degree elbow (140). It has been found that the inclusion of 90 degree angles can facilitate the retro-fitting of flat spray nozzles onto existing wash racks by controlling the distance of the nozzles from a plate to be cleaned.

The wash rack further comprises a transverse connecting member (133) connecting the front fluid feed pipe (131) and the rear fluid feed pipe (132).

In an embodiment, fluid is fed to the front fluid feed pipe (131) and the rear fluid feed pipe (132) separately. Alternatively, the transverse connecting member (133) defines a fluid pathway between the front fluid feed pipe (131) and the rear fluid feed pipe (132) such that fluid fed via an inlet (134) on the frame (130) flows through each of the front fluid feed pipe (131), the rear fluid feed pipe (132) and the transverse connecting member (133). In an embodiment, the inlet (134) is on the transverse connecting member. As shown in FIG. 2, the transverse connecting member (133) may be offset relative to the front and rear feed pipes (131, 132).

The wash rack (100) may further comprise edge spray assemblies (150) for cleaning of the filter plate upper and lower edges (14, 16). As shown in the Figures, the wash rack (100) comprises a front upper edge spray arrangement, a front lower edge spray arrangement, a rear upper edge spray arrangement, and a rear lower edge spray arrangement. Two edge spray assemblies (150) are positioned such that the front spray nozzles (110) are located between the respective upper and lower edge spray assemblies. Similarly, a further two edge spray assemblies are positioned such that the rear front spray nozzles (120) are located between respective upper and lower edge spray assemblies.

Each edge spray assembly (150) comprises a leading edge spray nozzle (151) and a trailing edge spray nozzle (152). Each edge spray nozzle (151, 152) is a flat spray nozzle of the type described above with regard to the front and rear spray nozzles. In an embodiment, the edge spray nozzles are oriented to provide an angled spray impact pattern (321, 322) similar to or the same as the spray impact pattern (310) provided by the front and rear spray nozzles (110, 120). The spray angle of the edge spray nozzles may be any spray angle as described above. In an embodiment, the spray angle of the edge spray nozzles (151, 152) is less than the spray angle of the front and rear spray nozzles (110, 120). In an embodiment, the spray angle of the edge spray nozzles (151, 152) is 30 degrees and the spray angle of the front and rear spray nozzles (110, 120) is 80 degrees.

With reference to FIG. 2, each edge spray assembly (150) is forked, wherein the leading edge spray nozzle (151) and the trailing edge spray nozzle (152) are connected via a V-shaped connector (153). The V-shaped connector is in fluid communication with one of the fluid feed pipes (131, 132). The edge spray nozzles are oriented such that the spray impact pattern (310) of the front or rear spray nozzles is positioned between the leading edge spray impact pattern (321) and the trailing edge spray impact pattern (322).

The wash rack (100) may further comprise a filter plate underside edge spray assembly comprising a spray nozzle (135) on the transverse connecting member (133) at a midpoint between the front fluid feed pipe (131) and the rear fluid feed pipe (132). The underside edge spray nozzle (135) may be a flat spray nozzle of the type described above with regard to the front and rear spray nozzles or the edge spray nozzles. In an embodiment, the underside edgy spray nozzles is oriented such that its elongate slot is perpendicular to the transverse connecting member (133). The spray angle of the underside edge spray nozzle (135) may be any spray angle as described above. In an embodiment, the spray angle of the underside edge spray nozzle (135) is 30 degrees.

According to the present disclosure, there is further provided a cleaning system comprising a wash rack (100) disclosed herein and a filter plate carriage. The filter plate carriage is configured to receive and hold a filter plate for cleaning.

At least one of the wash rack (100) and the filter plate carriage is movable such that a filter plate held by the filter plate carriage moves relative to the front face spray assembly. In this way, fluid jets from the front spray nozzles (110) and rear spray nozzles (120) move across the front and rear surfaces of the filter plate, respectively, thereby to wash filter cake residue from the filter plate. In an embodiment, the filter plate carriage is fixed and comprises a cradle for holding a filter plate. The wash rack then moves such that fluid jets generated by the spray nozzles (110, 120) travel across the face of the filter plate from one side edge (15) to the other side edge (17).

According to the present disclosure, there is further provided a method of cleaning a filter plate. The method comprises generating a plurality of fan-shaped front jets from the plurality of front spray nozzles (110) spaced along the first axis and a plurality of fan-shaped rear jets from the plurality of rear spray nozzles (120) spaced along the second axis. The filter plate is positioned vertically, for example by a filter plate carriage, between the front and rear spray assemblies.

Once the filter plate is in position, at least one of the filter plate (10) and the wash rack (100) is moved such that relative movement of the filter plate (10) and wash rack (100) moves the fan-shaped front jets across the filter plate front face thereby to define a front face spray cleaning profile on the front face surface. Similarly, the relative movement moves the fan-shaped rear jets across the filter plate rear face thereby to define a rear face spray cleaning profile of the rear face surface.

The method comprises at least one cleaning pass moving the front and rear jets across the surfaces of the filter plate from one side edge to the other side edge. In accordance with an embodiment of the present disclosure, multiple cleaning passes may be undertaken in a cleaning cycle for the filter plate. The cleaning pass may be a forward cleaning pass from side edge (15) to side edge (17), or a reverse cleaning pass from side edge (17) to side edge (15). Where multiple cleaning passes are conducted during a cleaning cycle, a combination of forward and reverse passes, preferably alternating forward and reverse passes, may be used.

In an embodiment, the method of cleaning the filter plate (10) may comprise from 1 to 10 cleaning passes, for example from 2 to 6 cleaning passes. That is, the method may comprise 1 cleaning pass, 2 cleaning passes, 3 cleaning passes, 4 cleaning passes, 5 cleaning passes, 6 cleaning passes, 7 cleaning passes, 8 cleaning passes, 9 cleaning passes, or 10 cleaning passes. The cleaning passes may be forward cleaning passes, reverse cleaning passes, or combinations thereof.

The time taken for the front and rear jets to move from one side edge to the other side edge, the cleaning pass duration, may be varied. Where the method comprises multiple cleaning passes, each cleaning pass may have the same duration or may have different durations. For example, initial cleaning passes may have a longer duration as the initial build-up is removed from the filter plate, followed by subsequent cleaning passes of shorter duration to remove residual build-up. Alternatively, the initial cleaning passes may be shorter in duration than the subsequent cleaning passes.

The cleaning pass duration may be, for example, from 10 seconds to 2 minutes. The cleaning pass duration may be 10 seconds, 20 seconds, 30 seconds, 40 seconds, 50 seconds, 1 minute, 1 minute 10 seconds, 1 minute 20 seconds, 1 minute 30 seconds, 1 minute 40 seconds, 1 minute 50 seconds, or 2 minutes.

Preferably the number of cleaning passes and the cleaning pass duration(s) are selected to achieve the desired level of cleanliness of the filter press while minimising the total duration of the cleaning cycle. In this way, the filter plates can be more quickly returned to the filter press for subsequent filtrations. This in turn increases the volume of product being filtered over time, increasing production (and therefore income) from product sales.

In an embodiment, the method comprises one forward cleaning pass and one reverse cleaning pass, wherein each cleaning pass had a cleaning pass duration selected from 20 seconds or 40 seconds.

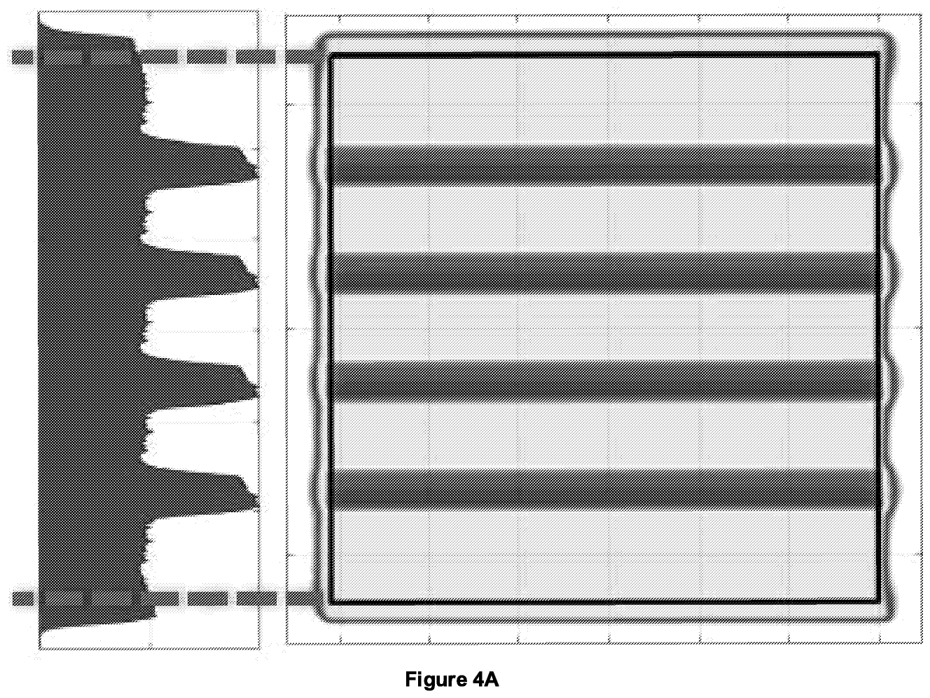

By way of non-limiting example, example cleaning profiles are shown in FIGS. 4(a) and 4(b), showing a wash rack with five spray nozzles and no edge nozzles (FIG. 4(a)) and a wash rack with five spray nozzles plus upper and lower edge nozzles (FIG. 4(b)). In FIGS. 4(a) and 4(b), the relative spray intensity across the face of the filter plate (10) during cleaning is shown. As can be seen, the spray cleaning profiles comprise a plurality of parallel cleaning bands, with each cleaning band associated with a respective fan-shaped jet (i.e. associated with one of the spray nozzles).

Each cleaning band at least partially overlaps, as indicated by the sections of increased intensity, with an adjacent cleaning band. The degree of overlap is not particularly limited and may be selected to ensure consistent, thorough cleaning of the plates. Each cleaning band may overlap with a certain percentage of an adjacent cleaning band. For example, each cleaning band may overlap with from 1-75%, for example from 5-50% of an adjacent cleaning band. That is, each cleaning band may overlap with an adjacent band by at least 1%, at least 5%, at least 10%, at least 15%, at least 20%, at least 25%, at least 30%, at least 35%, at least 40%, or at least 45%.

In an embodiment, the front face spray cleaning profile and the rear face spray cleaning profile are substantially identical.

It will be appreciated that the degree of overlap and the relative intensity across the filter plate surface can be controlled by varying, for example, the number of nozzles (including edge nozzles), the spray angle of the nozzles, the spacing of the nozzles along the axis.

Tables 1 and 2 below demonstrate that, for a single wash bay equipped with a wash frame according to the present disclosure comprising 10 fixed nozzles in an arrangement as shown in FIGS. 1 and 2, cleaning times and water usage for typical filter press operations can be greatly reduced by replacement of the rotor nozzles with the fixed nozzle arrangement according to the present disclosure.

TABLE 1
Comparison of rotor nozzle and fixed nozzle system for
34 frames per cleaning cycle and 2760 cycles per year

| | |
|---|---|
| Rotor nozzle | 2 × 5 fixed |
| system | nozzle system |

| | | |
|---|---|---|
| Cleaning time per frame | 1.2 min/frame | 0.867 min/frame |
| | (72 sec/frame) | (52 sec/frame) |
| Total cleaning time per | 40.8 min | 29.478 min |
| cycle (34 frames) | | |
| Total cleaning time over | 1876 hours | 1355 hours |
| a year (2760 cycles) | 48 minutes | 58.8 minutes |

| Time saved over a year | 520 hours 49.02 minutes | | | |
|---|---|---|---|---|
| Total water usage per frame | 35.4 | gal | 29.34 | gal |
| Total water usage per cycle | 1203.6 | gal | 997.56 | gal |

| (34 frames) | |
|---|---|
| Water saved over a year | 568,670.4 gal |
| (2760 cycles) | |

TABLE 2
Comparison of rotor nozzle and fixed nozzle system for
29 frames per cleaning cycle and 1200 cycles per year

| | |
|---|---|
| Rotor nozzle | 2 × 5 fixed |
| system | nozzle system |

| | | |
|---|---|---|
| Cleaning time per frame | 1.2 min/frame | 0.867 min/frame |
| | (72 sec/frame) | (52 sec/frame) |
| Total cleaning time per | 34.8 min | 25.143 min |
| cycle (29 frames) | | |
| Total cleaning time over | 696 hours | 502 hours |
| a year (1200 cycles) | | 51.6 minutes |

| Time saved over a year | 193.14 hours 8.4 minutes | | | |
|---|---|---|---|---|
| Total water usage per frame | 35.4 | gal | 29.34 | gal |
| (incl. edge nozzles) | | | | |
| Total water usage per cycle | 1026.6 | gal | 850.86 | gal |

(29 frames)

| | |
|---|---|
| Water saved over a year | 140,244 gal |

(1200 cycles)

It has been found that it is possible to retro-fit front and rear fixed nozzles (110, 120) to existing rotating nozzle type wash frames without the need to completely redesign existing wash bays and cleaning systems. The fixed nozzle system has been found to require less water and cleaning time as compared to the rotating nozzle equivalent. The fixed nozzle system disclosed herein does not require specialty nozzles, with the fixed nozzles easier and cheaper to source, and does not require the same level of maintenance as required by the moving parts of the rotating nozzle system. Further, the fixed nozzle arrangement has been found to consistently provide cleaning to the entire filter plate surface, with rotor nozzles often failing to cover the entire surface due to insufficient rotation of the rotors during the cleaning process.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A wash rack for cleaning filter plates, the wash rack comprising:
a filter plate front face spray assembly comprising a plurality of fixed front spray nozzles spaced along a first axis, wherein each front spray nozzle is a flat spray nozzle having a front spray nozzle outlet configured to produce a fan-shaped front jet, and wherein each front spray nozzle outlet is at an angle relative to the first axis, the angle of the front spray nozzle outlet defining the angle of the produced fan-shaped front jet relative to the first axis.

2. A wash rack according to claim 1, wherein the wash rack further comprises:
a filter plate rear face spray assembly comprising a plurality of fixed rear spray nozzles spaced along a second axis, the second axis spaced from the first axis, wherein each rear spray nozzle is a flat spray nozzle having a rear spray nozzle outlet configured to produce a fan-shaped rear jet, wherein each rear spray nozzle outlet is directed toward the first axis, and wherein each rear spray nozzle outlet is at an angle relative to the second axis, the angle of the rear spray nozzle outlet defining the angle of the produced fan-shaped rear jet relative to the second axis.

3. A wash rack according to claim 2, wherein:
the rear spray nozzle outlet of each rear spray nozzle is directly facing the front spray nozzle outlet of a corresponding front spray nozzle; and
the rear spray nozzle outlet of each rear spray nozzle is aligned with the front spray nozzle outlet of the corresponding front spray nozzle.

4. A wash rack according to claim 2, wherein the front spray nozzles and the rear spray nozzles have an 80 degree spray angle.

5. A wash rack according to claim 1, wherein the front spray nozzles are evenly spaced along the first axis.

6. A wash rack according to claim 1, wherein the front spray nozzle outlet of each front spray nozzle is angled at from 1-15 degrees relative to the first axis.

7. A wash rack according to claim 6, wherein the front spray nozzle outlet of each front spray nozzle is angled at 5 degrees relative to the first axis.

8. A wash rack according to claim 2, further comprising a wash rack frame, wherein the front face spray assembly and the rear face spray assembly are mounted on the wash rack frame.

9. A wash rack according to claim 8, wherein the wash rack frame comprises:
a front fluid feed pipe in fluid communication with each of the plurality of front spray nozzles; and
a rear fluid feed pipe in fluid communication with each of the plurality of rear spray nozzles.

10. A wash rack according to claim 9, further comprising:
a plurality of 90 degree elbows extending laterally from the front fluid feed pipe connecting each of the plurality of front spray nozzles to the front fluid feed pipe; and
a plurality of 90 degree elbows extending laterally from the rear fluid feed pipe connecting each of the plurality of rear spray nozzles to the rear fluid feed pipe.

11. A wash rack according to claim 9, wherein the wash rack frame further comprises a transverse connecting member defining a fluid pathway between the front fluid feed pipe and the rear fluid feed pipe.

12. A wash rack according to claim 11, further comprising a filter plate underside edge spray assembly comprising a spray nozzle on the transverse connecting member at a midpoint between the front fluid feed pipe and the rear fluid feed pipe.

13. A wash rack according to claim 2, wherein:
the filter plate front face spray assembly comprises a front upper edge spray arrangement and a front lower edge spray arrangement, wherein the plurality of front spray nozzles are located between the front upper edge spray arrangement and the front lower edge spray arrangement; and
the filter plate rear face spray assembly comprises a rear upper edge spray arrangement and rear lower edge spray arrangement, wherein the plurality of rear spray nozzles are located between the rear upper edge spray arrangement and the rear lower edge spray arrangement.

14. A cleaning system comprising:
a wash rack comprising a filter plate front face spray assembly comprising a plurality of fixed front spray nozzles spaced along a first axis, wherein each front spray nozzle is a flat spray nozzle having a front spray nozzle outlet configured to produce a fan-shaped front jet, and wherein each front spray nozzle outlet is at an angle relative to the first axis, the angle of the front spray nozzle outlet defining the angle of the produced fan-shaped front jet relative to the first axis; and
a filter plate carriage,
wherein at least one of the wash rack and the filter plate carriage is movable such that a filter plate held by the filter plate carriage moves relative to the front face spray assembly.

15. A cleaning system according to claim 14, wherein the wash rack further comprises a filter plate rear face spray assembly comprising a plurality of fixed rear spray nozzles spaced along a second axis, the second axis spaced from the first axis, wherein each rear spray nozzle is a flat spray nozzle having a rear spray nozzle outlet configured to produce a fan-shaped rear jet, wherein each rear spray nozzle outlet is directed toward the first axis, and wherein each rear spray nozzle outlet is at an angle relative to the second axis, the angle of the rear spray nozzle outlet defining the angle of the produced fan-shaped rear jet relative to the second axis; and
wherein relative movement of the wash rack and the filter plate moves the filter plate carried by the filter plate carriage between the filter plate front face spray assembly and the filter plate rear face spray assembly.

16. A method of cleaning a filter plate having a front face and a rear face, the method comprising:
generating a filter plate front face cleaning spray, the front face cleaning spray comprising a plurality of fan-shaped front jets from a plurality of front outlets spaced along a first axis, wherein each of the fan-shaped front jets is fixed at an angle relative to the first axis;
positioning a filter plate spaced from the first axis; and
moving at least one of the front face cleaning spray and the filter plate,
wherein relative movement of the filter plate and the front face cleaning spray moves the fan-shaped front jets across the filter plate front face thereby to define a front face spray cleaning profile on the front face surface, the front face spray cleaning profile comprising a plurality of parallel front cleaning bands, each front cleaning band associated with a respective fan-shaped front jet, wherein each front cleaning band at least partially overlaps with an adjacent front cleaning band.

17. A method according to claim 16, further comprising:
generating a filter plate rear face cleaning spray, the rear face cleaning spray comprising a plurality of fan-shaped rear jets from a plurality of rear outlets spaced along a second axis, the second axis spaced from the first axis, wherein each of the fan-shaped rear jets is directed toward the first axis and is fixed at an angle relative to the second axis,
wherein relative movement of the filter plate and the rear face cleaning spray moves the fan-shaped rear jets across the filter plate rear face thereby to define a rear face spray cleaning profile on the rear face surface, the rear face spray cleaning profile comprising a plurality of parallel rear cleaning bands, each rear cleaning band associated with a respective fan-shaped rear jet, wherein each rear cleaning band at least partially overlaps with an adjacent rear cleaning band.

18. A method according to claim 17, wherein the front face spray cleaning profile and the rear face spray cleaning profile are substantially identical.

19. A method according to claim 16, wherein each of the fan-shaped front jets is fixed at a 5 degree angle relative to the first axis.

20. A method according to claim 17, wherein each of the fan-shaped rear jets is fixed at a 5 degree angle relative to the second axis.
